(19) United States
(12) Patent Application Publication
(10) Pub. No.: US 2008/0172508 A1
(43) Pub. Date: Jul. 17, 2008

(54) Method and an Arrangement for Arbitrating Requests to Grant Access to Shared Resources

(76) Inventors: Tilman Gloekler, Gaertringen (DE); Thuyen Le, Taufkirchen (DE); Thomas Pflueger, Leinfelden (DE); Matthias Woehrlc, Bietigheim-Bissingen (DE)

Correspondence Address: W. Riyon Harding;International Business Machines Corporation, 1000 River Street, 972 E, Essex Junction, VT, 05452, US

(21) Appl. No.: 11/972,648

(22) Filed: Jan. 11, 2008

(30) Foreign Application Priority Data
Jan. 15, 2007 (DE) 07100541.7

(51) Int. Cl. G06F 13/372

(52) U.S. Cl. 710/117

(57) ABSTRACT

The present invention relates to a method for arbitrating requests from masters to grant access to shared resources, wherein each master has an individual weight. The method comprises the steps of assigning time slots to the masters depending on the weights of the masters, mapping the current time slot index (32) to a reordering index (30), receiving a plurality of requests from N masters, reordering the requests into a request vector (14) depending on the reordering index (30), searching for predetermined logical values in the request vector (14), generating a grant vector (18) according to the index of the found logical values in the request vector (14), inversely reordering the grant vector (18) into an output grant vector (22) depending on the reordering index (30), and calculating a new time slot index (32) on the basis of the current time slot index (30) and the grant vector (18). Further the present invention relates to a system for performing the method.

### CROSS REFERENCES TO RELATED APPLICATIONS

This application is related to German Patent Application No. 07100541.7, filed Jan. 15, 2007.

### FIELD OF THE INVENTION

The present invention relates to a method for arbitrating requests from masters to grant access to shared resources. Further the present invention relates to an arrangement for arbitrating requests from masters to grant access to shared resources.

### DESCRIPTION OF RELATED ART

An electronic system, in particular a computer system with peripheral components, usually includes an arbitration logic system. Said arbitration logic system is provided for arbitrating between requests received from multiple requesting masters and for granting access to a resource for a selected one of the requesting masters. For example, the requesting master may be a keyboard, a modem, a serial port, a video controller or a content processor. The resource may be an interconnect bus, a memory unit or an output buffer, for example. There are some situations, in which a device may be either the requesting master and/or the arbitrated resource.

A weighted round-robin arbitration scheme allows the assigning of an individual weight to different requesting masters to gain an access to common resources. The common resources may be hardware resources such as buses, for example. The weight is assigned and is a numerical value. However, depending on the grant history, the master with the highest weight can also loose arbitration. The weight is a measure of the probability of the corresponding master to win the arbitration against other competing masters. The weights of the masters allow a statistical distribution of the grants to the requests.

A special and simple case of a weighted round-robin scheme is the non-weighted round-robin scheme or simply called round-robin scheme. In the non-weighted round-robin scheme each master has the same weight and thus the same probability. An arbitration control unit based for the non-weighted round-robin scheme is based on a cyclical grant fashion. If the master does not raise its request, then it will be skipped during the search. If all N masters n=0 to n=N−1 are requesting the common resource, then a first grant is given to the first master n=0 in a first arbitration round, a second grant is given to the second master n=1 in a second arbitration round and so on. In a further cycle the (N+1)-th grant is given to the first master n=0 again, and so on.

The arbitration control units according to the prior art have to memorize the index of the last granted master and will start from this position to search for the next raised request in the next arbitration round. If the master n=K would have been granted last time, then the next arbitration round will start with the master n=K+1 for the next arbitration round. The arbitration control unit of the round-robin scheme implements a cyclical search for the first requesting master from the last granted position. If all masters always raise requests, then each master will be fairly granted in every N-th arbitration round.

The weighted round-robin arbitration is a modification of the round-robin arbitration such that in a full load situation every master will be granted as often as given by its a-priori weight. A full load situation occurs if all masters are raising requests and will be continuously raising requests again after having been granted. For example, if the three masters A, B, and C have the weights W(A)=1, W(B)=2 and W(C)=3, respectively, then said masters will get ⅙, ⅓ and ½ of the grants, respectively.

Application WO 00/38376 describes a method and an arrangement for scheduling and arbitration for a use in a digital switching system. A weighted round-robin schedule is expanded into a non-weighted round-robin schedule. In the expanded schedule the number of the masters is higher than the number of the real masters.

US 2005/0071210 A1, titled “a method, a system and an apparatus for an adaptive weighed arbiter” describes a weighted arbiter. Each master is characterized by a weight and by an accumulator. The accumulators are initialized at first on the basis of their weights. The arbiter gives a grant to that master with the largest accumulator. Then, the accumulator of said granted master is decreased while the accumulators of the non-granted masters are increased by some means.

The article “Programmable weighted arbiters for constructing switch schedulers” of Mei Yang et al. (High Performance Switching and Routing, IEEE, 2004, pages 203-206) describes an arbiter with a round-robin scheme. Each master has a priority value in binary coding. The arbiter searches that master with the highest priority value.

### SUMMARY OF THE INVENTION

The above object is achieved by a method and an arrangement as laid out in the independent claims. Further advantageous embodiments of the present invention are described in the dependent claims and are taught in the description below.

The core idea of the invention is the mapping of a current time slot index to a reordering index and the mapping of both grant index and current time slot index to the next time slot index. The reordering index depends on the current time slot index and is used to reorder the requests according to the weights of the masters for the current arbitration round. The search of the next certain logical value in the reordered request vector sets a grant for one of the masters. The resulting grant vector is inversely reordered and then mapped to a new time slot index for the next arbitration round.

The advantage of the present embodiment is the reduced latency since the mapping of the time slot index to the reordering index is a simple operation. The computation of the next time slot index based on the grant index can be hidden by the protocol in certain cases if the arbitration does not have to be performed back to back without waiting for the granted access to be completed.

Another advantage is the reduced complexity of the arrangement.

### BRIEF DESCRIPTION OF THE DRAWINGS

The above as well as additional objectives, features and advantages of the present invention become apparent in the following detailed written description.

The novel and inventive features believed to the characteristics of the invention are set forth in the appended claims. The invention itself and its advantages are best understood by reference to the following detailed description of preferred embodiments in conjunction with the accompanied drawings, wherein:

FIG. 1 illustrates a schematic flow chart diagram of a method as well as a schematic diagram of a corresponding arrangement according to a preferred embodiment of the present invention, and

FIG. 2 illustrates a schematic diagram of a priority encoder according to a preferred embodiment of the present invention.

### DETAILED DESCRIPTION OF THE INVENTION

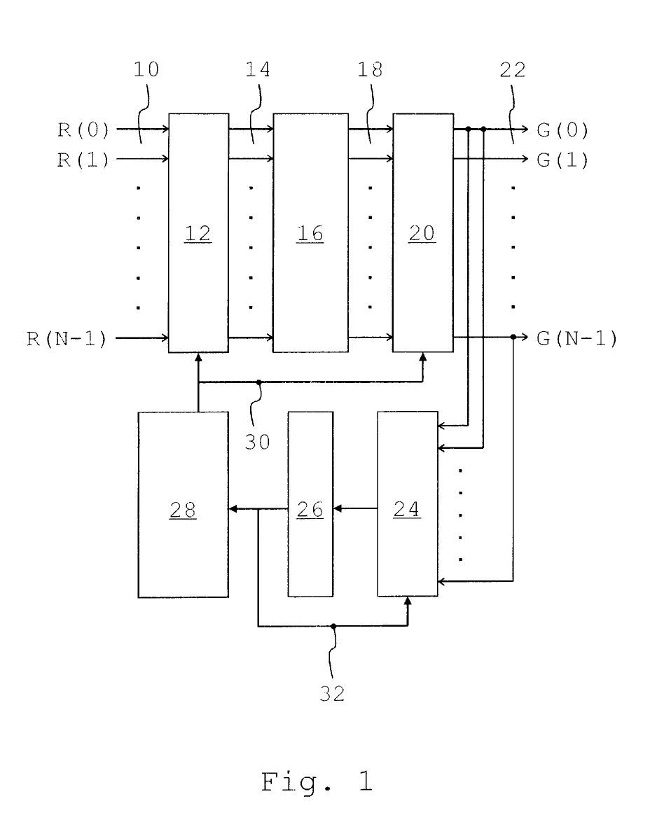

FIG. 1 illustrates a schematic flow chart diagram of a method according to a preferred embodiment of the present invention. The schematic diagram in FIG. 1 illustrates further a corresponding arrangement for performing said method. In this embodiment N requests R(0), R(1), . . . R(N-1) are received from N masters. The requests R(0), R(1), . . . R(N-1) form an input request vector 10. Within the input request vector 10 the requests R(0), R(1), . . . , R(N-1) are ordered according to the numbers of the N masters. To each of the N masters a weight W(N) is assigned. The weight may have a predetermined constant value depending on the type of the corresponding master. Alternatively the weight may have a programmable value depending on the type of the corresponding master. Further, a part of the weights may have predetermined constant values and another part of the weights may have programmable values, wherein at least one of the weights is programmable. For example, the weights W(N) are represented by integer numbers, normalized integer values and/or bench mark values.

In a step 12 the input request vector 10 is reordered according to a predetermined scheme into a request vector 14. The reordering algorithm depends on the weight W(N) of the master, from which the request R(N) has been received, and on the grant history, which is implicitly given by the current time slot index.

In a next step 16 the first logical “one” starting either from left or right is searched in the request vector 14. In this way the step 16 computes a grant vector 18, which is one-hot encoded, i.e. there is only one logical “one” in the grant vector 18.

In a step 20 the grant vector 18 is inversely reordered into an output grant vector 22. The output grant vector 22 includes N grants G(0), G(1), . . . , G(N-1).

In a further step 24 a current time slot index 32 and a grant index are mapped according to a predetermined mapping scheme in order to determine the next time slot index 32. In a step 26 the newly computed time slot index 32 is stored.

In a next step 28 the time slot index 32 is mapped to a reordering index 30. The reordering index 30 is used in the step 12 for reordering the input request vector 10 into the request vector 14 and in the step 20 for inversely reordering the grant vector 18 into the output grant vector 22.

The following example describes a weighted round-robin problem with five masters called A, B, C, D and E. The weights of said five masters have the integer values W(A)=1, W(B)=3, W(C)=5, W(D)=2 and W(E)=4, respectively. Then the sum of the weight is 15.

At first a time slot assignment is defined. The time slot assignment is not unique. Usually the time slots are assigned to the masters in such a way, that if all masters would request the resource all the time and back to back, e.g. full load situation, then a simple moving from one time slot to the next time slot will yield the desired bandwidth assignment. The following table shows a possible time slot assignment for a system with five masters A, B, C, D and E.

| | Time slot index | | | | | | | | | | | | | | |
|---|---|---|---|---|---|---|---|---|---|---|---|---|---|---|---|
| | 0 | 1 | 2 | 3 | 4 | 5 | 6 | 7 | 8 | 9 | 10 | 11 | 12 | 13 | 14 |
| Master | C | E | B | D | C | E | B | D | C | E | B | A | C | E | C |

In this example the assignment can grant the resource to the master C twice back to back when moving from the time slot “14” to “0” with master C raising request. The example assumes that the current time slot index is 8, and masters A, B and D raise their requests. The requests R(0)=R(A), R(1)=R(B), R(2)=R(C), R(3)=R(D) and R(4)=R(E) of the input request vector 10 have to be reordered into the request vector 14 with the elements R0=R(2)=R(C), R1=R(4)=R(E), R2=R(1)=R(B), R3=R(0)=R(A) and R4=R(3)=R(D), so that the master C would be granted, if it would request. Otherwise the master E would be granted, if it would request, and so on.

The following table shows the complete reordering scheme for the given example. Each reordering is associated with one of said reordering indices 30.

| Reordering | Highest | 2^{nd} highest | 3^{nd} highest | 4^{nd} highest | lowest |
|---|---|---|---|---|---|
| index | priority | priority | priority | priority | priority |
| 0 | C | E | B | D | A |
| 1 | C | E | B | A | D |
| 2 | E | B | D | C | A |
| 3 | E | B | A | C | D |
| 4 | E | C | B | D | A |
| 5 | B | D | C | E | A |
| 6 | B | A | C | E | D |
| 7 | D | C | E | B | A |
| 8 | A | C | E | B | D |

Depending on the current time slot index 32, a specific reordering scheme is selected to reflect the priorities set for the masters by the slot assignment. The following table shows the relationship between the time slot indices 32 and the corresponding reordering indices 30.

| | Time slot index | | | | | | | | | | | | | | |
|---|---|---|---|---|---|---|---|---|---|---|---|---|---|---|---|
| | 0 | 1 | 2 | 3 | 4 | 5 | 6 | 7 | 8 | 9 | 10 | 11 | 12 | 13 | 14 |
| Reordering index | 0 | 2 | 5 | 7 | 0 | 2 | 5 | 7 | 1 | 3 | 6 | 8 | 0 | 4 | 0 |

The step 12 of reordering the input request vector 10 into the request vector 14 may be implemented by a multiplexer.

The search for the first logical “one” in the request vector 14 may be implemented by a priority encoder. The elements of the grant vector 18 on the output of said priority encoder have to be inversely reordered to yield the output grant vector 22. The grant index is coded as “0” for the master A, as “1” for the master B and so on to match the order of the masters A, B, C, D and E according to the assignment of inputs request to input request vector 10.

Given the grant index, in the step 24 the grant index and the current time slot index 32 are combined in order to determine the next time slot index 32 for the next arbitration round.

The following table illustrates the mapping properties.

| | 0 | 1 | 2 | 3 | 4 | 5 | 6 | 7 | 8 | 9 | 10 | 11 | 12 | 13 | 14 |
|---|---|---|---|---|---|---|---|---|---|---|---|---|---|---|---|
| A => 0 | 12 | 12 | 12 | 12 | 12 | 12 | 12 | 12 | 12 | 12 | 12 | 12 | 12 | 12 | 12 |
| B => 1 | 3 | 3 | 3 | 7 | 7 | 7 | 7 | 11 | 11 | 11 | 11 | 3 | 3 | 3 | 3 |
| C => 2 | 1 | 5 | 5 | 5 | 5 | 9 | 9 | 9 | 9 | 13 | 13 | 13 | 13 | 0 | 0 |
| D => 3 | 4 | 4 | 4 | 4 | 8 | 8 | 8 | 8 | 4 | 4 | 4 | 4 | 4 | 4 | 4 |
| E => 4 | 2 | 2 | 6 | 6 | 6 | 6 | 10 | 10 | 10 | 10 | 14 | 14 | 14 | 14 | 2 |

With the above example it is assumed that the current time slot index is 8. For the masters, the priority order C>E>B>A>D is assigned according to the time slot assignment. Assuming that the masters C and D do not raise request, but the masters B and A, then the resource will be granted to the master B and the next time slot index shall be 11 according to the table above.

A simplified mapping is shown in the table below. The grant index is achieved with a rotation by 1 to the next time slot. Then, the granting order is not strictly round-robin in non full load situation. However, in a full load situation, the simplified mapping behaves exactly as the more complicated mapping in the example above.

| | 0 | 1 | 2 | 3 | 4 | 5 | 6 | 7 | 8 | 9 | 10 | 11 | 12 | 13 | 14 |
|---|---|---|---|---|---|---|---|---|---|---|---|---|---|---|---|
| A => 0 | 1 | 2 | 3 | 4 | 5 | 6 | 7 | 8 | 9 | 10 | 11 | 12 | 13 | 14 | 15 |
| B => 1 | | | | | | | | | | | | | | | |
| C => 2 | | | | | | | | | | | | | | | |
| D => 3 | | | | | | | | | | | | | | | |
| E => 4 | | | | | | | | | | | | | | | |

FIG. 1 illustrates a schematic flow chart diagram of a method as well as a schematic diagram of a corresponding arrangement for performing the method. The arrangement includes a reordering device 12, a search device 16, an inverse reordering device 20, a first mapping device 24, a register 26 and a second mapping device 28. The reordering device 12 and the inverse reordering device 20 may be realized by a multiplexer. The search device 16 may be realized by a prioritized multiplexer.

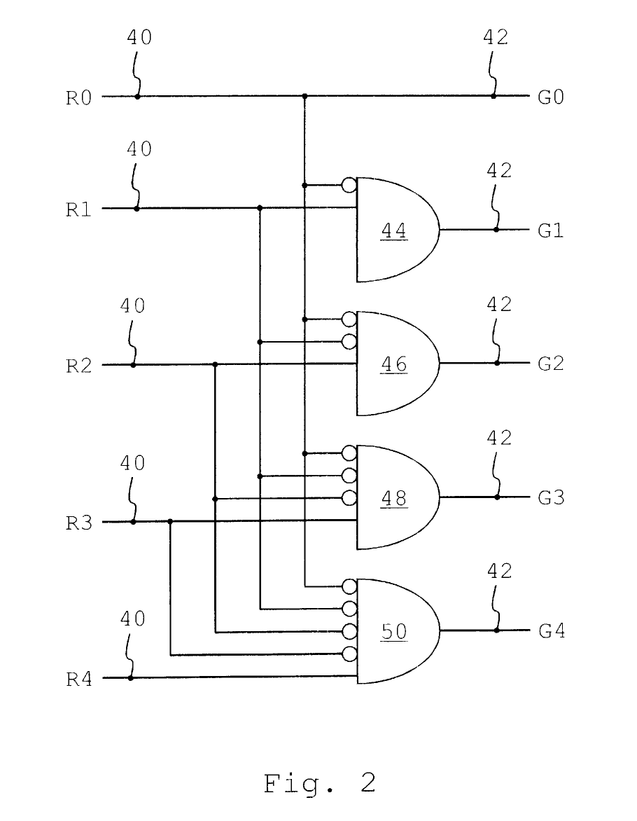

FIG. 2 illustrates a schematic diagram of an example for a priority encoder. The priority encoder is an example for the device 16 in FIG. 1. In this example the priority encoder includes five input lines 40 and five output lines 42. The input lines 40 are provided for the inputs R0, R1, R2, R3 and R4 of the request vector 14, respectively. The output lines 42 are provided for the outputs G0, G1, G2, G3 and G4 of the grant vector 18, respectively.

The input lines 40 are connected to the inputs of four NAND gates 44, 46, 48 and 50 according to predetermined scheme. Four of the output lines 42 are connected to the outputs of the NAND gates 44, 46, 48 and 50, respectively. One of the output lines 42 is directly connected to one of the input lines 40, so that the elements R0 and G0 have always the same value.

The inverted element R0 and the non-inverted element R1 are connected to the inputs of the first NAND gate 44. The inverted elements R0 and R1 as well as the non-inverted element R2 are connected to the inputs of the second NAND gate 46. The inverted elements R0, R1 and R2 as well as the non-inverted element R3 are connected to the inputs of the third NAND gate 48. The inverted elements R0, R1, R2 and R3 as well as the non-inverted element R4 are connected to the inputs of the forth NAND gate 50. The priority encoder is provided for searching the first logical “one”. The original requests R(0), R(1), R(2), R(3) and R(4) of the input value 10 have been reordered and mapped to the elements R0, R1, R2, R3 and R4 in the step 12 or the corresponding reordering device 12.

If R0 and R1 have the logical value “zero” and R2 has the logical value “one”, then the element G2 has the logical value “one” and the other elements G0, G1, G3 and G4 have the logical value “zero”.

The elements G0, G1, G2, G3 and G4 need to be inversely reordered again to match the position of the incoming request inputs.

If there are many masters and therefore many input lines a binary tree of priority encoders may be used.

The method according to the present embodiment of the invention allows a very fast scheduling of the requests and arbitration of the grants for the access to the resources. The arrangement according to the present invention also allows a reduced chip area.

The method and the arrangement according to the present invention may be applied to any system or network, in which an arbitration occurs.

The arrangement according to an embodiment present invention may be provided for a communication system or a communication network. In particular, the arrangement is provided for a computer system or a computer network. The masters of the arrangement may be components or peripheral components of a communication system or a communication network and of a computer system or a computer network, respectively. The resources of the arrangement may be common used components of a communication system or a communication network. In particular, the resources of the arrangement are commonly used components of a computer system or a computer network.

The present embodiment can also be embedded in a computer program product, which comprises all the features enabling the implementation of the methods described herein. Further, when loaded in a computer system, the computer program product is able to carry out these methods.

Although illustrative embodiments of the present invention have been described herein with reference to the accompanying drawing, it is to be understood that the present invention is not limited to those precise embodiments, and that various other changes and modifications may be affected therein by one skilled in the art without departing from the scope or spirit of the invention. All such changes and modifications are intended to be included within the scope of the invention as defined by the appended claims.

### LIST OF REFERENCE NUMERALS

10 input request vector

12 step of reordering; reordering device

14 request vector

16 step of searching the logical “one”

18 grant vector

20 step of inverse reordering; inverse reordering device

22 output grant vector

24 step of mapping the current time slot index

26 step of storing; register

28 step of mapping the time slot index to reordering index

30 reordering index

32 time slot index

40 input line

42 output line

44 first NAND gate

46 second NAND gate

48 third NAND gate

50 fourth NAND gate

1. A method of arbitrating requests from a plurality of masters to grant access to shared resources, wherein each master has a weight, comprising:
a) assigning a plurality of time slots to each of the plurality of masters depending on the weights of said masters;
b) mapping a current time slot index (32) to a reordering index (30);
c) receiving at least one request from at least one of the masters;
d) reordering said request into a request vector (14) depending on the reordering index (30);
e) searching for at least one predetermined logical value in the request vector (14);
f) generating a grant vector (18) according to the index of said predetermined logical value in the request vector (14);
g) inversely reordering the grant vector (18) into an output grant vector (22) depending on the reordering index (30); and
h) calculating a new time slot index (32) based on the current time slot index (30) and the output grant vector (22).

2. The method according to claim 1, wherein at least one weight has a predetermined constant value depending on the type of the corresponding master.

3. The method according to claim 1, wherein at least one weight has a programmable value depending on the type of the corresponding master.

4. The method according to claim 1, wherein at least one the weights is programmable.

5. The method according to claim 1, wherein the weights are represented by numerical values.

6. The method according to claim 5, wherein the weights are represented by normalized integer values.

7. The method according to claim 5, wherein the weights are represented by bench mark values.

8. The method according to claim 1, wherein the requests received from the masters are ordered into an input request vector (10) according to the numbers of the masters.

9. The method according to claim 1, wherein the grant vector (18) is inversely reordered according to the order of the receiving requests.

10. A system for arbitrating requests from a plurality of masters to grant access to shared resources, wherein each master has a weight, comprising:
a) plurality of masters having a plurality of time slots dependent on the weights of said masters;
b) a reordering index (30) which is mapped to a current time slot index (32);
c) a request generated from at least one of the masters;
d) a request vector (14) comprising reordering said request depending on the reordering index (30);
e) at least one predetermined logical value in the request vector (14);
f) a grant vector (18) comprised according to the index of said predetermined logical value in the request vector (14);
g) an output grant vector (22)generated by inversely reordering the grant vector (18) depending on the reordering index (30); and
h) a new time slot index (32) calculated based on the current time slot index (30) and the output grant vector (22).

11. The system according to claim 10, wherein the system is a communication system or a communication network.

12. The system according to claim 10, wherein the system is a computer system or a computer network.

13. The system according to claim 10, wherein the masters are components or peripheral components of a communication system or a communication network.

14. The system according to claim 10, wherein the masters are components or peripheral components of a computer system or a computer network.

15. The system according to claim 10, wherein the resources are common used components of a communication system or a communication network.

16. The system according to claim 10, wherein the resources are common used components of a computer system or a computer network.

17. The system according to claim 10, wherein the system includes a priority encoder for searching the predetermined logical values in the request vector (14).

18. The method according to claim 1, wherein the system is realized in hardware, software or a combination of hardware and software.

19. A computer program product stored on a computer usable medium, comprising computer readable program means for causing a computer to:
assign a plurality of time slots to each of the plurality of masters depending on the weights of said masters;
map a current time slot index (32) to a reordering index (30);
receive at least one request from at least one of the masters;
reorder said request into a request vector (14) depending on the reordering index (30);
search for at least one predetermined logical value in the request vector (14);
generate a grant vector (18) according to the index of said predetermined logical value in the request vector (14);
inversely reorder the grant vector (18) into an output grant vector (22) depending on the reordering index (30); and
calculate a new time slot index (32) based on the current time slot index (30) and the output grant vector (22).
